(19) United States
(12) Patent Application Publication
(10) Pub. No.: US 2008/0184372 A1
(43) Pub. Date: Jul. 31, 2008

(54) STORAGE DEVICE, DATA PROCESSING DEVICE, DATA PROCESSING SYSTEM, AND PROGRAM

(75) Inventor: Masaki HOSHINA, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 12/020,200

(22) Filed: Jan. 25, 2008

(30) Foreign Application Priority Data
Jan. 26, 2007 (JP) 2007-016415

(51) Int. Cl. G06F 21/00

(52) U.S. Cl. 726/24

(57) ABSTRACT

A storage device includes a data storage unit storing a virus pattern of a computer virus, a virus data detection unit for detecting with use of the virus pattern as to whether data as a target to be written contains the virus, and a controller for enabling writing of the data into the data storage unit in the case where the virus data detection unit does not detect the virus.

The entire disclosure of Japanese Patent Application No. 2007-016415, filed Jan. 26, 2007 is expressly incorporated by reference herein.

### BACKGROUND OF THE INVENTION

1. Technical Field

The present invention relates especially to a portable storage device, a data processing device for exchanging data with the storage device, a data processing system including the storage device and the data processing device, and a program designed to make the storage device and the data processing device perform a specific process.

2. Related Art

A computer virus is generally detected by virus detection software installed in a computer. JP-A-9-269930 is an example of related art. However, portable storage devices are not equipped with a function of preventing virus penetration. Examples of the portable storage device are a contactless identification tag, a USB memory, an SD card, and an IC card.

In many cases, especially RFIDs, memory cards, or the like are equipped with an interface socket for enabling read and write operations with portable devices other than PCs. Differently from the PCs, the virus detection software is not installed in the portable devices.

Therefore, virus data specifically for the portable devices, which does not function as a virus in the PCs, for example, is written in the IC card, the contactless identification tag, or the memory card connected to the PC, which brings about the possibility of infecting the portable device with the virus in the case where the written IC card, the contactless identification tag, or the memory card is thereafter used in the portable device.

### SUMMARY

An advantage of the present invention is to provide a storage device for preventing writing of data including a computer virus, a data processing device for processing the data, a data processing system, and a program.

According to a first aspect of the invention, a storage device includes a data storage unit storing a virus pattern of a computer virus, a virus data detection unit for detecting with use of the virus pattern as to whether data as a target to be written contains the virus, and a controller for enabling writing of the data into the data storage unit in the case where the virus data detection unit does not detect the virus.

In this manner, upon input of data as the target to be written, the virus data detection unit detects as to whether the data contains the virus. In the case where the virus is not detected, the controller enables writing of the data into the data storage unit. Therefore, only the data containing no computer virus is written into the data storage unit.

It is preferable that the controller disable the writing of the data into the data storage unit in the case where the virus data detection unit detects the virus. It is preferable that the controller go into a sleep state in the case where the virus data detection unit detects the virus. In this manner, writing of the data containing the virus can be prevented.

It is preferable that the controller verify as to whether the virus pattern stored in the storage unit is updated, before a process by the virus data detecting unit. In this manner, the virus detection process can be performed to the data as the target to be written, using the most up-to-date virus pattern.

It is preferable that the storage device further include a display unit for displaying a detection result by the virus data detection unit. In this manner, the use can be informed of a virus detection result.

It is preferable that the display unit hold a display state in a power-off state. In this manner, the user can confirm the virus detection result by visual recognition of display on the display unit even where the storage device is not connected to the data processing device.

According to a second aspect of the invention, a data processing device for exchanging data with a storage device, the data processing device includes a verification unit for verifying a version of a virus pattern stored in the storage device, before writing of the data into the storage device, and an update unit for updating the virus pattern stored in the storage device in the case where the verification unit determines that the version of the virus pattern is not the most up-to-date.

In this manner, the virus pattern stored in the storage device is updated by the verification unit and the update unit before writing of the data into the storage device. Therefore, the storage device achieves a virus check with higher accuracy.

According to a third aspect of the invention, a data processing system includes a storage device, and a data processing device for exchanging data with the storage device, in which the storage device has a data storage unit storing a virus pattern of a computer virus, a virus data detection unit for detecting with use of the virus pattern as to whether the data as a target to be written from the data processing device contains the virus, and a controller for enabling writing of the data into the data storage unit in the case where the virus data detection unit does not detect the virus, and in which the data processing device has a verification unit for verifying a version of the virus pattern stored in the storage device, before writing of the data into the storage device, and an update unit for updating the virus pattern stored in the storage device in the case where the verification unit determines that the version of the virus pattern is not the most up-to-date.

In this manner, the virus pattern stored in the storage device is updated by the verification unit and the update unit of the data processing device before writing of the data into the storage device. Thereafter, the data as the target to be written is output from the data processing device.

Upon input of the data as the target to be written, the storage device side detects using the virus data detection unit as to whether the data contains the virus. In the case where the virus is not detected, the controller enables writing of the data into the data storage unit. Therefore, only the data containing no computer virus is written into the data storage unit.

According to a fourth aspect of the invention, a program makes a storage device for exchanging data with a data processing device perform a process that includes a step of detecting as to whether the data input as a target to be written from the data processing device contains a computer virus, and a step of writing the data into the storage device in the case where the virus is not detected.

According to a fifth aspect of the invention, a program makes a storage device for exchanging data with a data processing device perform a process that includes a step of verifying a version of a virus pattern stored in a storage device before output of the data to the storage device, and a step of updating the virus pattern stored in the storage device in the case where the verification unit judges that the version of the virus pattern is not the most up-to-date.

### BRIEF DESCRIPTION OF THE DRAWINGS

The invention will be described with reference to the accompanying drawings, wherein like numbers reference like elements.

FIG. 1 is a view showing a configuration of a data processing system according to a first embodiment.

FIG. 2 is a view showing a processing flowchart of a data processing device according to the first embodiment.

FIG. 3 is a view showing a processing flowchart of a storage device according to the first embodiment.

FIG. 4 is a view showing a configuration of a data processing system according to a second embodiment.

FIG. 5 is a view showing a processing flowchart of a data processing device according to the second embodiment.

FIG. 6 is a view showing a processing flowchart of a storage device according to the second embodiment.

### DESCRIPTION OF EXEMPLARY EMBODIMENTS

Embodiments according to the present invention will be described hereinafter with reference to drawings.

### First Embodiment

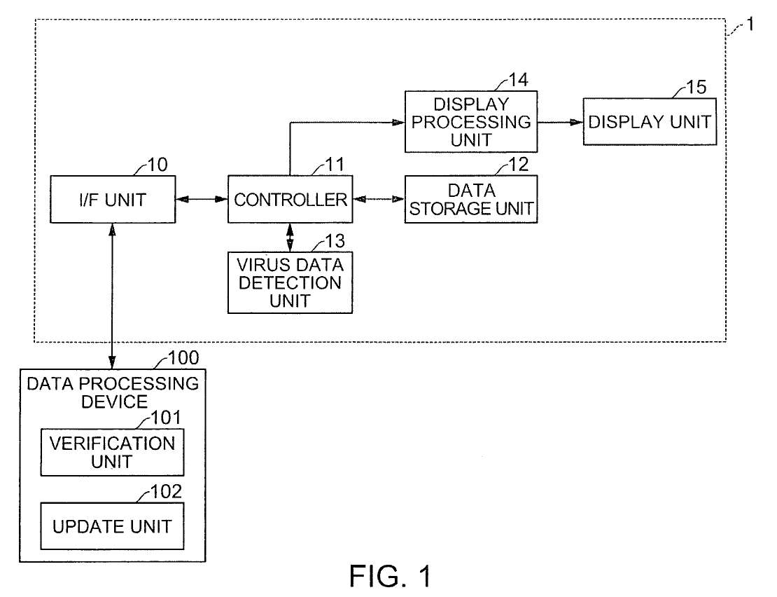

FIG. 1 is a view showing a configuration of a data processing system according to this embodiment.

The data processing system according to this embodiment includes a storage device 1 and a data processing device 100. An example of the storage device 1 is a USB memory. Example of the data processing device 100 is a computer or other portable device such as a PDF or a cellular phone.

The storage device 1 according to this embodiment is defined as a nonvolatile memory capable of detecting whether or not data contains virus data before writing of the data. The storage device 1 includes an interface (I/F) unit 10, a controller 11, a data storage unit 12, a virus data detection unit 13, a display processing unit 14, and a display unit 15.

The I/F unit 10 has a function for data transfer between the data storage unit 12 and the data processing device 100 as a host. The I/F unit 10 is defined as an interface for building a connection to a host interface. The I/F unit 10 may be a wireless interface such as a short-range wireless interface or a wireless communication interface, not a wired interface.

The controller 11 has a function of controlling data transfer between the interface unit 10 and the data storage unit 12 to thereby control the data transfer between the storage device 1 and the data processing device 100. In the case of writing data into the data storage unit 12, the controller 11 controls the virus data detection unit 13 to detect whether or not the data contains the computer virus data. The controller 11 also has a function of notifying the data processing device 100 of a detection result by the virus data detection unit 13.

The data storage unit 12 is composed of a nonvolatile memory such as a flash memory, an EEPROM, or an FeRAM. The data storage unit 12 stores virus pattern data. The virus pattern data is preferably the most up-to-date.

The virus data detection unit 13 compares the virus pattern data previously stored in the data storage unit 12 and the data written into the data storage unit 12 through the interface unit 10, and judges that the data contains the computer virus in the case where there is a full or partial match between the aforementioned data and virus pattern data. The judgment result is then notified to the controller 11. In the case where a judgment is made that the data to be written into the data storage unit 12 contains the computer virus data, the controller 11 disables writing of the aforementioned data into the data storage unit 12 to thereby discard the data. Thereafter, the controller 11 notifies a host side through the interface unit 10 that the computer virus is contained in the data.

The virus data detection unit 13 functions to detect the computer virus by a general detection method. Examples of the general detection methods are a pattern matching method and a rule base system.

The pattern matching method is such that a characteristic part in the virus data is taken out as a characteristic pattern and is then compiled in a database to be matched with a data string as a detection target. In the case of detecting the same characteristic pattern, a judgment is made that the data contains the virus data.

The rule base system is to make a judgment through monitoring of operation of a running program, in which such a program is judged as a virus, that runs in agreement with a rule, which is previously specified as a pattern data used for identifying a virus through analysis of a virus activity. This system detects, for example, operation of a program to remain hidden fraudulently in a memory such as the data storage unit 12 or operation to rewrite fraudulently data, which is read out from the data storage unit 12 by a host device from, and then to write the data into the data storage unit again as the same file.

The display processing unit 14 is defined as a driving circuit for the display unit 15, which includes a TFT or segment type of a backplane circuit or a driver circuit.

It is preferable that the display unit 15 provide a nonvolatile display. An electrophoretic display is a representative example. This display is characterized in that displayed data can remain displayed even after power-off. A detection result by the virus data detection unit is displayed on the display unit. Even where the virus is not detected, the display unit displays a no-virus-detected status and a version of the virus pattern used for examination. Even where a user carries the storage device, since the display unit is defined as the nonvolatile display, he can confirm on the spot as to which version is used for examination and as to whether the virus is detected. Therefore, it is no longer necessary to insert the storage device into a PC or a PDA to confirm the version used for examination.

Likewise the storage device 1, the data processing device 100 includes an I/F unit, a controller, a data storage unit, a virus data detection unit, a display processing unit, and a display unit, not shown. In this embodiment, the data processing device 100 particularly include a verification unit 101 for verifying the version of the virus pattern stored in the storage device 1, before writing of the data into the storage device 1, and an update unit 102 for updating the virus pattern stored in the storage device 1 in the case where the verification unit 101 judges that the version of the virus pattern is not the most up-to-date.

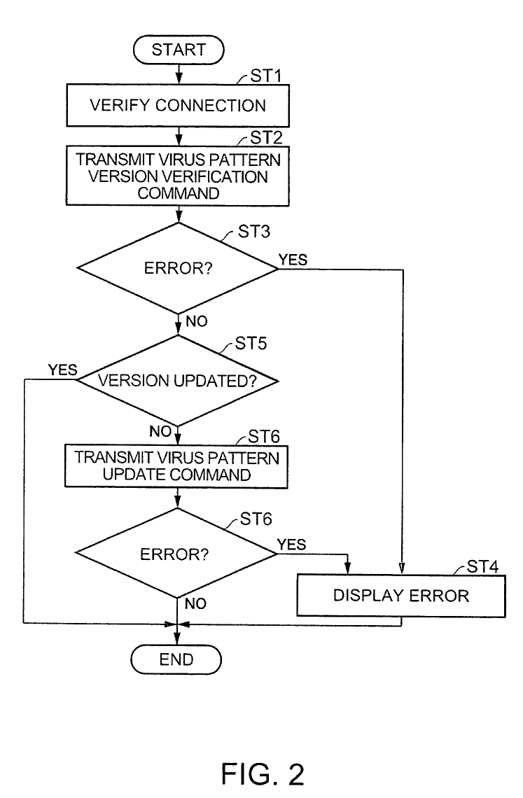

FIG. 2 is a view showing a processing flowchart of the data processing device according to this embodiment. FIG. 2 shows a flowchart of a process that the data processing device 100 updates the virus pattern data stored in the storage device 1 before reading and writing data between the storage device 1 and the data processing device 100. The processing flowchart shown in FIG. 2 is executed by making the data processing device 100 as a computer read the program according to this embodiment. The data processing device 100 is preferably defined as a special PC or as a portable device that always stores the most up-to-date pattern data but may be defined as other devices.

Upon verification of connection of the storage device 1 to the data processing device 100 at the step ST1, the data processing device 100 transmits a version verification command of a virus pattern to a storage device 2 at the step ST2. The storage device 2 side transmits version information of the virus pattern.

Upon receipt of the version information of the virus pattern from the storage device 2, a judgment is made at the step ST5 as to whether the received version of the data pattern is the most up-to-date. For this judgment, a comparison made between a version of the virus pattern stored in the data storage unit 12 and the most up-to-date version of the virus pattern stored in the data processing device 100. In the event of error in receipt of the version information of the virus pattern at the step ST3, an error status is displayed at the step ST4.

In the case of judgment that the version of the virus pattern is the most up-to-date at the step ST5, this process is terminated. Thereafter, data is read and written between the data processing device 100 and the storage device 1.

In the case of judgment that the version of the virus pattern is not the most up-to-date at the step ST5, the data processing device 100 transmits a virus pattern update command at the step ST6. In the event of error in transmission of the virus pattern update command at the step ST7, the error status is displayed.

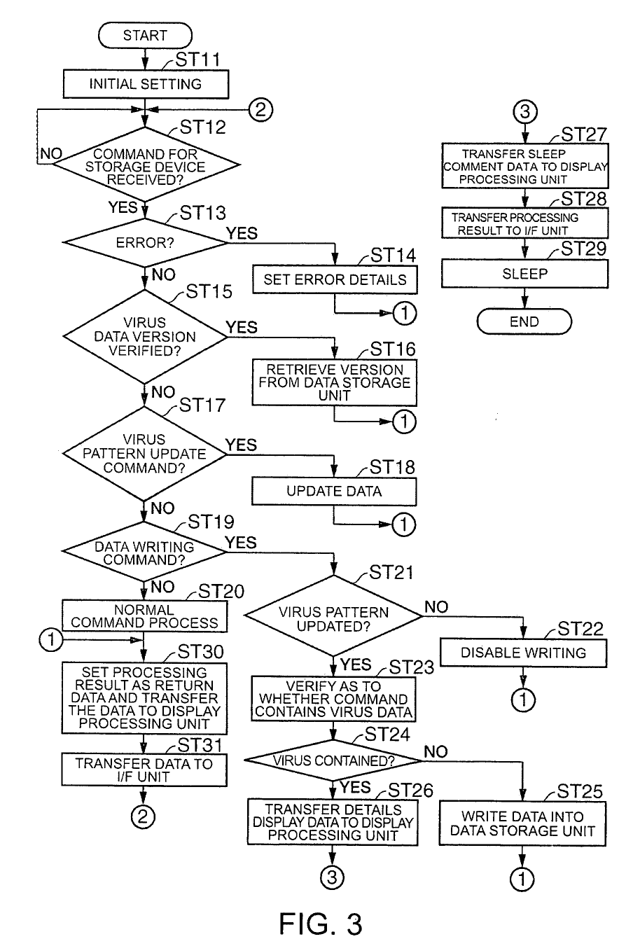

FIG. 3 is a view showing a processing flowchart of the storage device according to this embodiment. A program designed to perform the process in this the processing flowchart is stored in the data storage unit 12, for example.

As shown in FIG. 3, an appropriate initial setting is made at the step ST11 and then verification is made at the step ST12 as to whether a command is given to the storage device 1. In the case where the command is given to the storage device 1 but some kind of error occurs at the step ST13, error details are set at the step ST14.

Upon receipt of the command given to the storage device 1 without error, in which the command is the version verification command of the virus data at the step ST15, the controller 11 retrieves a version of the virus pattern from the data storage unit 12 at the step ST16. The version information is transferred to the display processing unit 14 to thereby be displayed on the display unit 15 at the step ST30. The version information is further transferred to the I/F unit 10 to thereby be transferred to the data processing device 100 at the host side as the step ST31.

Upon receipt of the virus pattern update command from the data processing device 100 at the host side at the step ST17, the controller 11 updates the data of the virus pattern stored in the data storage unit 12 at the step ST18. In the case where the data is updated, a data-updated status and the updated version information are transferred to the display processing unit 14 to thereby be displayed on the display unit 15 at the step ST30. The data-updated status and the updated version information are further transferred to the I/F unit 10 to thereby be transferred to the data processing device 100 at the host side at the step ST31.

After the process for updating the virus pattern data described above, a data writing command can be received from the data processing device 100. Verification is made at the step ST19 as to whether the command received from the data processing device 100 is the data writing command.

In the case where the data is other than the data writing command, the normal command process is performed at the step ST20. In the normal command process, a processing result by the controller 11 is also transferred to the display processing unit 14 to thereby be displayed on the display unit 15 at the step ST30. The processing result is further transferred to the I/F unit 10 to thereby be transferred to the data processing device 100 at the host side at the step ST31.

In the case of receipt of the data writing command at the step ST19, verification is made at the step ST21 as to whether, the virus pattern data is updated. In the case where the virus pattern data is not updated, the controller 11 disables writing into the data storage unit 12.

In the case where the virus pattern data is updated, the virus data detection unit 13 makes verifies whether or not the writing command contains the virus data at the step ST23.

In the absence of the virus at the step ST24, the data is written into the data storage unit 12 at the step ST25. Thereafter, the data-written status is transferred to the display processing unit 14 to thereby be displayed on the display unit 15 at the step ST30. The data-written status is further transferred to the I/F unit 10 to thereby be transferred to the data processing device 100 at the host side at the step ST31.

In the presence of the virus at the step ST25, the virus-existence status is transferred to the display processing unit 14 to thereby be displayed on the display unit 15 at the step ST26. The status that the state goes into sleep mode is transferred to the display processing unit 14 at the step ST27, and the processing result is transferred to the I/F unit 10 to thereby be transferred to the data processing device 100 at the host side at the step ST28, so that the state goes into sleep mode at the step ST29.

As described above, according to the storage device and the program in this embodiment, the detection can be made as to whether the data as a target to be written contains the virus data. Therefore, this invention is effective especially for a portable storage device that is usable on different platforms. Thus, such a situation can be avoided that the virus data stored in the storage device is read into the device without a virus detection function to thereby allow activation of the virus.

The virus detection result is displayed on the display unit 15 of the storage device so that the user can confirm that the virus data does not exist in the storage device without examination by connecting the storage device to the PC again.

In this embodiment, in the case where a judgment is made that the data as a target to be written contains the virus data, it is highly possible that a computer such as a PC or a PDA as a connection destination is infected with the virus, so that storage device 1 is shifted in sleep mode. Thus, any access from the connection destination is blocked to thereby prevent access for changing the subsequent program of the storage device 1.

Before writing of the data, the storage device 1 side verifies whether or not the virus pattern is updated at the step ST21, which ensures performance of a process for updating the virus pattern before check of the virus.

According to the data processing device and the program in this embodiment, a process for verifying whether or not the virus pattern inside the storage device 1 is the most up-to-date is performed at the time of connecting the data processing device to the storage device 1, which allows the virus pattern inside the storage device 1 to be always the most up-to-date.

### Second Embodiment

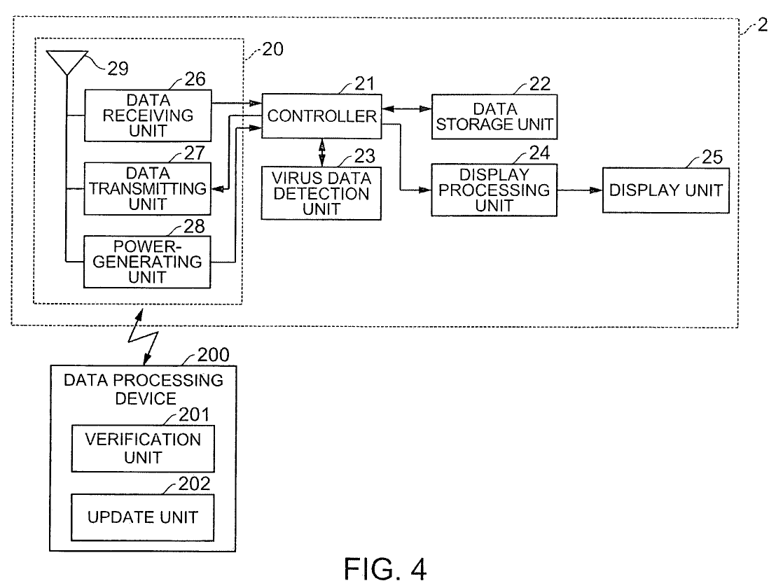

FIG. 4 is a block diagram of a data processing system in the case where the storage device according to the invention is applied to an IC card or a contactless identification tag. The data processing system includes the storage device 2, a data processing device (a reader/writer device) 200 for exchanging data with the storage device 2. In this embodiment, an I/F unit 20 includes an antenna unit 29 for transmitting and receiving a magnetic field, a data receiving unit 26 for receiving a signal from the antenna unit 29, a data transmitting unit 27 for transmitting a signal to the antenna unit 29, and a power-generating unit 28 for generating electric power by electromagnetic induction.

A controller 21 analyzes a communication command transmitted from the reader/writer device through the I/F unit 20 and accesses a data storage unit 22 in accordance with a direction of the command. The IC card or the contactless identification tag has a unique identification ID (UID) and this ID is stored in the data storage unit 22.

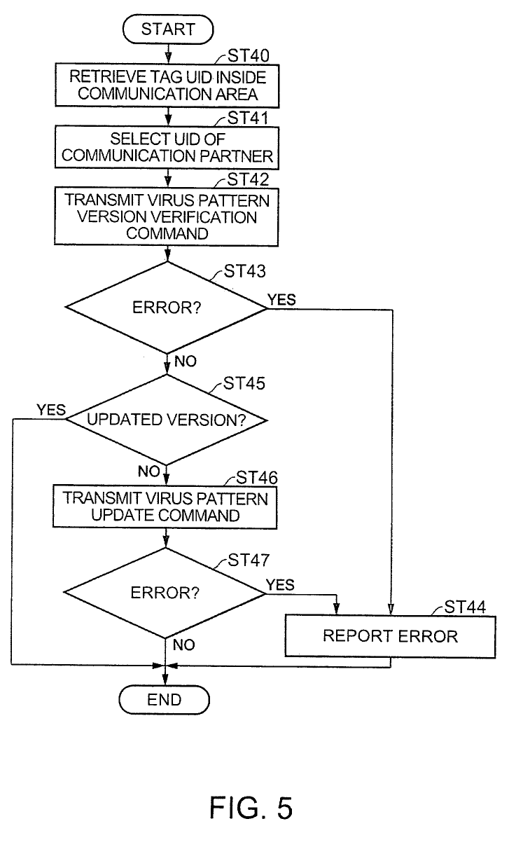

The data processing device 200 uses this UID in the case of communication with the IC card or the contactless identification tag. The controller 21 reads out this ID to thereby make a judgment as to whether the command from the data processing device 200 is given to the storage device 2. The data processing device 200 includes an antenna unit, a data receiving unit, a data transmitting unit, a controller, and a storage unit. Those units have functions similar to those of the storage device 2, respectively, so that the duplicated explanation is omitted. The communication command between the data processing device 200 and the contactless identification tag is standardized. The normal command process shown in FIG. 5 and the memory writing command are performed in compliance with ISO/IEC18000-3 or ISO/IEC15693. Herein, the standard is not limited to ISO/IEC18000-3 or ISO/IEC15693. With respect to the IC card, the communication command is standardized in compliance with ISO/IEC14443 as a contactless system but the standard is not limited thereto.

FIG. 5 is a view showing a processing flowchart of the data processing device as the reader/writer device according to this embodiment. FIG. 5 shows a flowchart of a process that the data processing device 200 updates the virus pattern data stored in the storage device 2 before reading and writing of the data between the storage device 1 and the data processing device 200. The processing flowchart shown in FIG. 5 is executed by making the data processing device as the reader/writer device read the program according to this embodiment.

The data processing device 200 retrieves the UID of the IC card or the contactless identification tag inside a communication area at the step ST40 and selects the IC card or the contactless identification tag as a communication partner at the step ST41 to thereby transmit the virus pattern version verification command to the IC card or the contactless identification tag having the UID at the step ST42.

A process to update the virus pattern data is performed through the steps ST42 to ST47 in a manner similar to that performed through the steps ST2 to ST7 in the first embodiment.

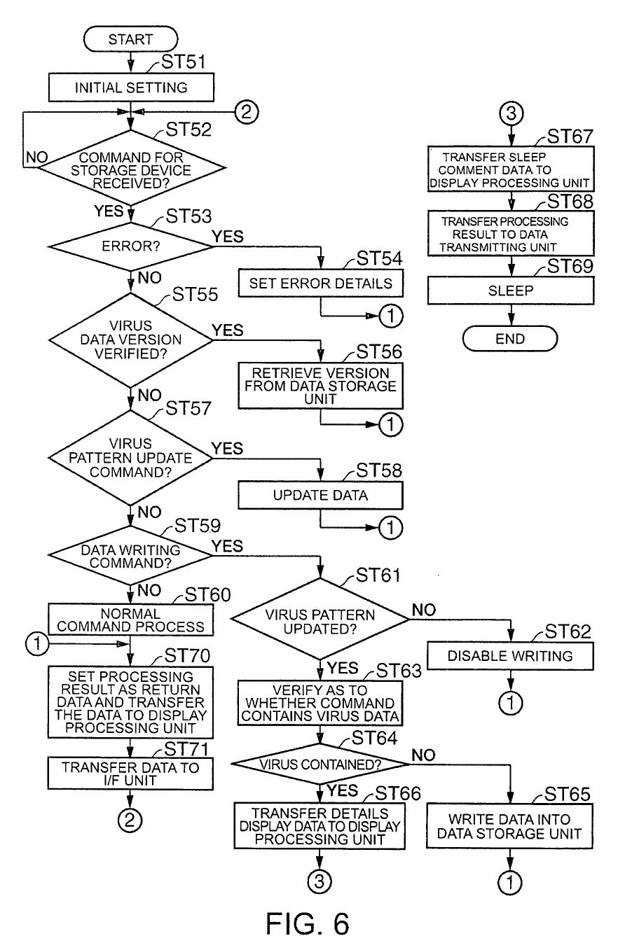

FIG. 6 is a view showing a processing flowchart of the storage device according to this embodiment. A program designed to perform the process in this the processing flowchart shown in FIG. 6 is stored in the data storage unit 22, for example.

The processing flowchart shown in FIG. 6 is about the same as that shown in FIG. 3, so that the duplicated explanation is omitted. In this embodiment, the data transmitting unit 27 of the I/F unit 20 transmits the processing result to the data processing device 200 at the steps ST71 and ST68.

The virus pattern version verification command in FIGS. 5 and 6 is in compliance with a protocol of ISO/IEC18000-3, ISO/IEC15693, or ISO/IEC14443 but is not set as a standard command, thereby being additionally implemented as a vendor unique command. With respect to the standardized command, the virus data detection unit 23 verifies whether or not the data written into the data storage unit 22 according to the writing command contains the virus data. A verification method is similar to that of the first embodiment.

As described above, the storage device according to this embodiment can be applied even to the IC card or the contactless identification tag. Accordingly, the second embodiment can produce the effect similar to that of the first embodiment.

This invention is not limited to the embodiments described above.

Various changes may be made without departing from the scope of the invention.

This invention can be applied to a wireless communication chipset, a flash memory, an EEPROM, or an FeRAM equipped with virus detection function.

What is claimed is:

1. A storage device comprising:
a data storage unit storing a virus pattern of a computer virus;
a virus data detection unit for detecting with use of the virus pattern as to whether data as a target to be written contains the virus; and
a controller for enabling writing of the data into the data storage unit in the case where the virus data detection unit does not detect the virus.

2. The storage device according to claim 1, wherein the controller disables the writing of the data into the data storage unit in the case where the virus data detection unit detects the virus.

3. The storage device according to claim 1, wherein the controller goes into a sleep state in the case where the virus data detection unit detects the virus.

4. The storage device according to claim 1, wherein the controller verifies as to whether the virus pattern stored in the storage unit is updated, before a process by the virus data detecting unit.

5. The storage device according to claim 1, further comprising a display unit for displaying a detection result by the virus data detection unit.

6. The storage device according to claim 5, wherein the display unit holds a display state in a power-off state.

7. A data processing device for exchanging data with a storage device, the data processing device comprising:
a verification unit for verifying a version of a virus pattern stored in the storage device, before writing of the data into the storage device; and
an update unit for updating the virus pattern stored in the storage device in the case where the verification unit determines that the version of the virus pattern is not the most up-to-date.

8. A data processing system comprising:
a storage device; and
a data processing device for exchanging data with the storage device,
wherein:
the storage device includes:
a data storage unit storing a virus pattern of a computer virus,
a virus data detection unit for detecting with use of the virus pattern as to whether the data as a target to be written from the data processing device contains the virus; and
a controller for enabling writing of the data into the data storage unit in the case where the virus data detection unit does not detect the virus; and
the data processing device includes:
a verification unit for verifying a version of the virus pattern stored in the storage device, before writing of the data into the storage device; and
an update unit for updating the virus pattern stored in the storage device in the case where the verification unit determines that the version of the virus pattern is not the most up-to-date.

9. A program for making a storage device for exchanging data with a data processing device perform a process, the process comprising:
a step of detecting as to whether the data input as a target to be written from the data processing device contains a computer virus; and
a step of writing the data into the storage device in the case where the virus is not detected.

10. A program for making a storage device for exchanging data with a data processing device perform a process, the process comprising:
a step of verifying a version of a virus pattern stored in a storage device before output of the data to the storage device; and
a step of updating the virus pattern stored in the storage device in the case where the verification unit determines that the version of the virus pattern is not the most up-to-date.
